(19) United States
(12) Patent Application Publication
(10) Pub. No.: US 2025/0169609 A1
(43) Pub. Date: May 29, 2025

(54) SUPPORT AND RESTRAINT SYSTEM FOR THE HUMAN BODY, OR FOR A SEGMENT OF THE HUMAN BODY, PROVIDED WITH RETAINING MEANS

(71) Applicant: PRO MEDICARE S.R.L., Mesagne (BR) (IT)

(72) Inventor: Rosaria Eugenia CAFORIO, Mesagne (BR) (IT)

(21) Appl. No.: 18/868,739

(22) PCT Filed: May 19, 2023
(86) PCT No.: PCT/IB2023/055179

§ 371 Date: Nov. 23, 2024

(30) Foreign Application Priority Data
Jun. 15, 2022 (IT) 102022000012668

(51) Int. Cl. A47C 7/02

(52) U.S. Cl. CPC A47C 7/0213

(57) ABSTRACT

A support and restraint system for the human body, or for a segment of the human body, includes at least one padded element having a substantially tubular shape and at least one base element. The padded element and the base element are provided with respective retaining means for coupling the padded element to the base element. Due to the presence of the retaining means, the padded element of the system firmly maintains the arrangement conferred and defined thereto during set-up, even in the event of movements of the user.

### TECHNICAL FIELD

The present invention relates to a support and restraint system for the human body, or for a segment of the human body.

More particularly, the present invention relates to a support and restraint system for the human body, or for a segment thereof, of the type comprising a padded element which has a substantially tubular shape and is conformable to be able to adapt to the specific morphology of the individual user and their particular needs.

By way of non-limiting example, the present invention finds application in support and restraint systems for invalid people, disabled people and/or infants, and can be applied to medical devices supporting mobility, such as manual and/or electronic wheelchairs, to medical devices for rehabilitation and social or household life, such as bases with or without wheels for use indoor and/or in schools, to medical devices for transporting and keeping patients in a lying or semi-lying position for longer or shorter periods, such as hospital stretchers, hospital beds or the like.

### BACKGROUND ART

Correct posture is influenced by countless factors and is fundamental to an individual's physical well-being.

In particular, but without limitation, ensuring correct posture is essential for those persons who suffer from diseases, whether genetic or acquired, resulting from damages to the central nervous system, and do not possess self-control mechanisms that, by reacting to external stimuli, make it possible to avoid adopting incorrect postures.

Some diseases resulting from damages to the central nervous system lead to changes in body structure, which in turn lead to limitations in basic bodily functions, such as breathing, swallowing, communication, and so on. In addition, some diseases resulting from damages to the central nervous system may be accompanied by spasms and involuntary movements of one or more parts of the human body that may cause injury to the person themselves due to impacts against external objects and/or falls from a seat or bed.

For these people, correct posture and restraint, whether in a sitting or lying position, may even be essential for their very survival.

Even for infants in a good state of health, there is a need for body support systems that are adapted to the specific morphology of the individual and that are able to contain the individual's movements.

There is also a need for such support and restraint systems to ensure optimal user comfort as well as correct posture.

Support and restraint systems for one or more segments of the human body that take into account the specific morphology of the individual are known to the state of the art.

A known type of such support and containment systems has a structure consisting of a base element and one or more modules—with different shapes, sizes and stiffnesses—provided with means for being removably and reversibly connected to said base, so that the system, as a whole, is able to conform to the morphological structure of the individual user.

Although a support and restraint system of the type described above can take and firmly maintain an arrangement that perfectly adapts to the specific morphology of the individual and can be modified over time in the event that said morphology varies, it is complex and has a large number of components.

In particular, for the purpose of ensuring the possibility of adaptation to individuals with very different morphologies, it will be necessary to provide for a large number of different shapes and sizes.

Furthermore, the systems of the above-mentioned type have proved unsuitable for applications for supporting and restraining infants.

A different type of known support and restraint systems provides for using a padded element having a substantially tubular shape and being conformable to be able to adapt to the specific morphology of the individual user and their particular needs.

In particular, said padded element has an elongated shape, with a length much greater than the size of its own cross-section, whereby it can be manipulated so as to assume the desired profile and adapted to the specific needs of each application.

While, on one hand, a support and restraint system of the type described above is advantageously characterized by a great simplicity, on the other hand it is not without drawbacks.

In particular, it has poor stability, and the padded element can easily shift and, therefore, change its configuration, especially in the event of sudden movements or spasms of the user.

As highlighted above, correct posture is of vital importance, particularly for individuals suffering from certain diseases, and a change—even a limited one—in the configuration of the upholstered element can lead to improper posture, with even serious consequences for the user.

Document DE 202012001030 U1 discloses a padded cushion for medical use comprising an upper portion and a lower portion separated by a seam, whereby the padded cushion can be brought from an extended position, in which the upper portion and the lower portion are substantially coplanar, to a folded position in which the lower portion (by rotating with respect to the seam) is tilted and overlapped to the upper portion. Retaining means are provided on the upper portion and lower portion, respectively, to firmly maintain the cushion in said folded position.

The cushion described in DE 202012001030 U1 can take only the two configurations mentioned above and this makes it poorly versatile. Moreover, said cushion cannot in any way adapt or conform to users with different morphological features.

The main object of the present invention is therefore to overcome the limitations highlighted above, by providing a support and restraint system whose features can be varied according to the user's needs and which, at the same time, ensures correct restraint of the user even in the event that they make involuntary and sudden movements.

This and other objects are achieved with the support and restraint system as claimed in the appended claims.

### SUMMARY OF INVENTION

The support and restraint system according to the invention comprises at least one padded element having a substantially tubular shape, and at least one base element on which the padded element is placed, said at least one padded element having a substantially tubular shape and said at least one base element being distinct, independent and entirely separate components.

According to the invention, the aforementioned elements are provided with respective retaining means cooperating with each other.

Said retaining means are such as to ensure retaining of the at least one padded element relative to the at least one base element, so that said at least one padded element firmly maintains the arrangement conferred and defined thereto during set-up, even in the event of movements of the user.

In other words, the at least one padded element and the at least one base element are associated with each other so that possible displacements of the user do not correspond to slipping of said at least one padded element with respect to said at least one base element.

According to an embodiment of the invention, said retaining means are obtained by providing the padded element with a lining made of a non-slip material, at least at the portion facing the base element, and by correspondingly making the base element with a cover made of a non-slip material, at least at the face facing the padded element.

According to this embodiment, when the padded element is placed on the base element in a given configuration, the friction generated by the contact between the two surfaces of non-slip material ensures retaining of the padded element with respect to the base element.

According to a second embodiment of the invention, said retaining means are obtained by placing male/female connecting members on the face of the base element facing the padded element and by placing corresponding female/male connecting members on the portion of the padded element facing the base element.

According to this embodiment, when the padded element is placed on the base element, the coupling between the male/female connecting members of the base element and the female/male connecting members of the padded element allows preventing relative sliding of the padded element and the base element even in the event of movements of the user.

In particular, the connecting members of the base element can be made by using male/female hook-and-loop strips, and the connecting members of the padded element can be made by using female/male hook-and-loop strips.

Preferably, the male/female connecting members are arranged on some specific regions of the base elements, so that they can position and retain the padded element on the base element according to different configurations, whereas they are not provided in other regions of the base element, and in particular at those regions of the base element that may come in direct contact with the user when they use the support and restraint system and that may cause discomfort to the user.

Similarly, and for the same reasons, the regions of the padded element that may come into direct contact with the user are preferably left free of female/male connecting members so as not to cause discomfort to the user.

### BRIEF DESCRIPTION OF DRAWINGS

Further features and advantages of the present invention will become more evident from the ensuing detailed description of some preferred embodiments of the invention, given by way of non-limiting examples with reference to the annexed drawings, in which:

FIG. 1 is a perspective view of the support and restraint system according to a first embodiment of the invention;

FIG. 2 is a top view of the base element of a support and restraint system according to a second embodiment of the invention;

FIG. 3 is a bottom view of the padded element of a support and restraint system according to the second embodiment of the invention;

FIG. 4 is a top view of the support and restraint system according to a third embodiment of the invention.

### DESCRIPTION OF EMBODIMENTS

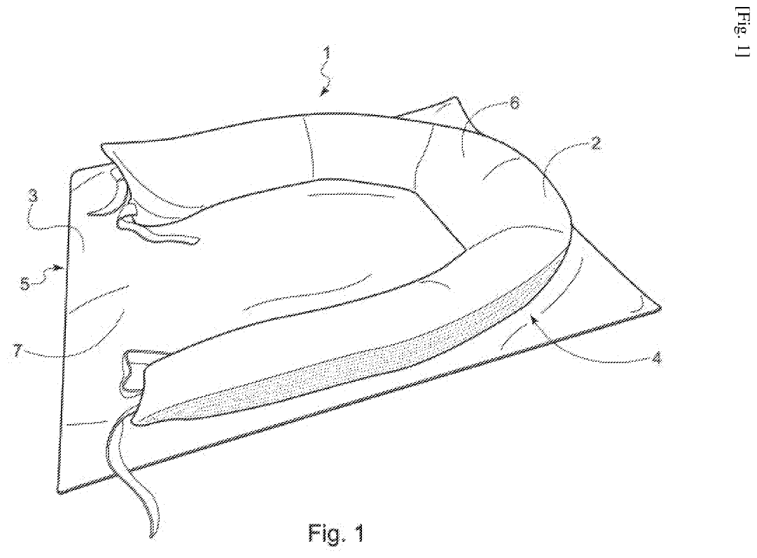

Referring to FIG. 1, this shows an embodiment of the invention in which the support and restraint system 1 is configured to be placed on an infant bed and comprises a single padded element and a single base element.

However, this embodiment should not be interpreted in a limiting sense, and the support and restraint system according to the invention could be made in many different ways, each adapted to support and restrain one or more body segments of the users, who can vary in age, physical conformation and health conditions.

For example, the present invention may be applied to support and restraint systems to be placed on wheelchairs, stretchers, beds, or other devices.

In addition, the present invention may consist of several padded elements and/or several base elements associatable to each other to form a complex modular structure, which can be adapted to the morphology of the user and/or to specific applications.

Referring to FIG. 1, the support and restraint system 1 comprises a padded element 2 having a substantially tubular shape, and a base element 3 on which the padded element 2 is placed.

Said padded element 2 having a substantially tubular shape and said base element 3 are distinct, independent and entirely separate components.

Said base element 3 may be made rigid or flexible.

If the base element 3 is made rigid, it may be flat or suitably shaped according to a specific application.

If, instead, the base element 3 is made flexible, it may preferably be made with a substantially flat shape, i.e., as a sheet of flexible material, so that it can be brought from an extended configuration of use, shown in FIG. 1, to a folded configuration of non-use, and vice versa.

Advantageously, thanks to the presence of a flexible base element 3, the overall dimensions of the support and restraint system 1 can be remarkably reduced when said system is not in use.

It should be noted that, if the system according to the invention has a modular structure and comprises a plurality of base elements, it will also be possible to associate rigid base elements with flexible base elements.

Referring to FIG. 1, the padded element 2 has an elongated tubular shape, with a length much greater than the size of its own cross-section. Said shape makes it possible to manipulate the padded element 2 so as to provide said element with the desired profile and adapt it to the specific needs of each application.

It should be noted that by tubular shape it is generically meant an elongated shape. The padded element 2 might have a cross-section constant along its whole length, but it might also have different cross-sections (for example, with a larger or smaller area) at different sections of its length.

In a manner known per se, the padded element 2 comprises a covering lining 6 and a padding inserted therein.

Said padding can be made by using one or more types and combinations of filling elements. The filling elements may be made with any stiffness and of any suitable material, such as high-performance polymer foams, foams that are cross-linked in order to promote aeration, viscoelastic foams with slow return shape-memory and similar materials.

The space inside the covering lining 6 may consist of a single compartment, or it may be divided into different sectors by introducing intermediate inner walls. In the latter instance, the padding of each sector, delimited by respective intermediate inner walls, can be made with a specific filling element (or a specific combination of filling elements).

For example, by placing a given filling element (or a specific combination of filling elements) in each sector it is possible to make, as a whole, a padding system with regions of different stiffnesses, thereby improving the user's comfort.

In addition, depending on the mutual distance set for the intermediate inner walls inside the covering lining 6, sectors with different sizes can be obtained. The possibility of having sectors with different sizes allows increasing the degree of customization of the padded element 2, making it possible to better adapt it to the needs of the individual.

In case, one or more rigid elements, possibly shaped, may be introduced inside the covering lining 6, between the padding and the inner wall of said lining.

Said rigid elements will be arranged under the padding, at the lower wall of the lining 6, and may be used, for example, to give the overlying padding a desired inclination.

With the aim of ensuring proper positioning of said rigid elements, the inner wall of the lining 6 may also be provided with suitable pockets.

The covering lining 6 of the padded element 2 will conveniently be provided with one or more zippers, or similar closure systems, which allow access therein and replacement of the padding (or of the padding of each sector, if the space inside the lining is divided in sectors).

Such replacement can be effected, for example, when it is necessary to make adjustments to the characteristics of the padded element, or when it is necessary to change the configuration of said padded element over time as a consequence of changes in the user's morphology.

According to the invention, the padded element 2 is provided with retaining means 4 for coupling to the base element 3.

Accordingly, the base element 3 is provided with retaining means 5 for coupling to the padded element 2.

The retaining means 4 of the padded element 2 are chosen so as to cooperate with the retaining means 5 of the base element 3, ensuring coupling between the padded element 2 and the base element 3.

In particular, said retaining means 4, 5 are chosen so as to establish coupling between the padded element 2 and the base element 3 in such a way that the padded element 2 can be retained on the base element 3 so as to prevent relative sliding between the padded element 2 and the base element 3, even in the event of movements of the user.

In this way, once the configuration of the padded element 2 has been defined, the retaining means 4, 5 make it possible to maintain this configuration even in the event of involuntary and sudden movements of the user.

The retaining means 4, 5 are chosen so as to establish coupling between the padded element 2 and the base element 3 in such a way that the padded element 2 can be applied in adjustable positions on the base element 3 and remove it therefrom if the need for replacement arises. This feature makes it possible to obtain the configuration best suited to the specific morphology of the individual user on a case-by-case basis.

The retaining means 4, 5 allowing coupling between the base element 3 and the padded element 2 can be obtained in different ways.

In particular, said retaining means 4, 5 may consist of continuous and distributed elements or of discrete elements.

According to the embodiment illustrated in FIG. 1, the base element 3 may have, on its surface, one or more portions with non-slip features.

Said portions with non-slip features can be obtained by making the base element 3 with a coating 7 totally or partially made of a non-slip material.

According to the same embodiment, the corresponding padded element 2 has a covering lining 6 totally or partially made of a non-slip material.

Alternatively, a further cover can be applied to the padded element 2, onto the covering lining 6, said further cover being capable of totally or partially covering the padded element 2 and being totally or partially made of a non-slip material.

Said non-slip materials can be, in particular, non-slip fabrics.

Said covering lining 6 (or its portions, where applicable) made of a non-slip material therefore constitutes the distributed retaining means 4 of the padded element 2, which cooperate with the distributed retaining means 5 of the base element 3, which consist of the cover 7 (or its portions, where applicable).

If the covering lining 6 is only partially made of a non-slip material (or is only partially covered by the aforementioned cover of non-slip material), said non-slip material will have to be arranged at least at the portion of the padded element 2 facing the base element 3.

In this way, when the padded element 2 is placed on the base element 3 in a given, desired configuration, the friction generated by the contact between the two surfaces of non-slip material will ensure retainment of the padded element 2 with respect to the base element 3 in said desired configuration.

It will be evident from the above that the base element 3 will be provided with the cover 7 constituting the retaining means 5 at least on the face of said base element facing the padded element 2.

On the opposite face, said base element 3 may still include additional connecting and retaining means for coupling to an outer support element (in this example, the infant bed).

Said further connecting or retaining means can be of the same nature as the retaining means 5, or they can also be of a different nature.

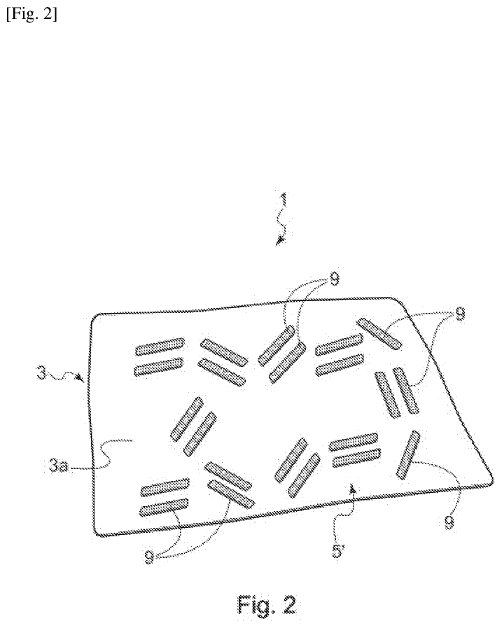

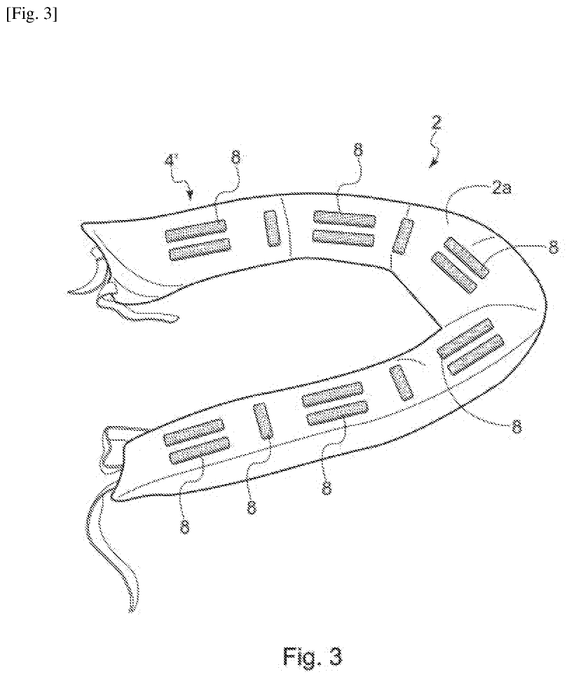

Another embodiment of the invention is shown in FIGS. 2 and 3. In this embodiment, too, the support and restraint system 1 is configured to be placed on an infant bed and comprises a single padded element and a single base element.

In this second embodiment of the invention, the retaining means 4′, 5′ of the padded element 2 and the base element 3 are made as discrete elements.

In particular, said retaining means 4′, 5′ are obtained by placing male/female connecting members 9 on the face 3a of the base element 3 facing said padded element 2 and by placing corresponding female/male connecting members 8 on the portion of said covering lining 6 of said padded element 2 at the face 2a of said padded element 2 facing said base element 3.

According to this embodiment, the coupling established when the padded element 2 is placed on the base element 3 and resulting from the interaction between the male/female connecting members 9 of the base element 3 and the female/male connecting members 8 of the padded element 2, allows preventing slippage between the padded element 2 and the base element 3 in the event of movements of the user.

Advantageously, said male/female connecting members 9 of the base element 3 and said female/male connecting members 8 of the padded element 2 are made so as to allow removable connection between said base element and said padded element, so that the padded element is repositionable on the base element and conformable to a plurality of configurations.

In particular, the connecting members of the base element 3 can be made by using male/female hook-and-loop strips 9, as shown in FIG. 2, and the connecting members of the padded element 2 can be made by using female/male hook-and-loop strips 8, as shown in FIG. 3.

As illustrated in FIG. 2, the male/female hook-and-loop strips 9 are preferably placed on some specific regions of the base element 3 so that the padded element 2 can be placed and retained on the base element 3 according to different configurations, whereas they are not provided in other regions of the base element 3, and in particular at those regions of the base element 3 that may come in direct contact with the user when they use the support and restraint system 1.

Similarly, and for the same reasons, the regions of the padded element 2 that may come into direct contact with the user are preferably left free of female/male connecting members 8 so as not to cause discomfort to the user.

In this embodiment, too, the base element 3 can be provided, on the face of said base element opposite to the face 2a facing the padded element 2, with further connecting or retaining members for coupling to an outer support element (in this example, the infant bed).

In this case, too, said further connecting or retaining means can be of the same nature as the retaining means 5′, or they can also be of a different nature.

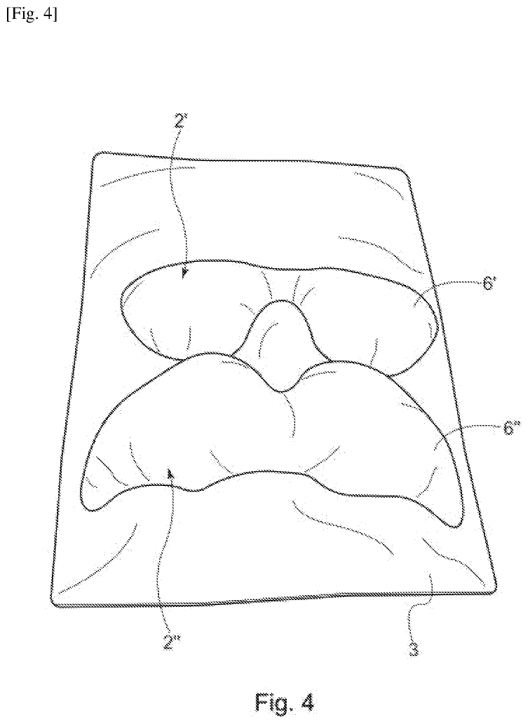

Turning now to FIG. 4, this shows a third embodiment of the support and restraint system according to the invention, in which said system comprises several padded elements 2′, 2″ associatable with each other to form a complex modular structure, which can be adapted to the morphology of the user.

In particular, in the illustrated example, the padded elements 2′, 2″ are associatable with each other to form a modular structure which is intended for supporting the head and can be adapted to the morphology of the individual user.

Each padded element 2′, 2″ will have a structure of the type illustrated in detail above with reference to the embodiments described above and will comprise, in particular, a covering lining 6′, 6″ and a padding inserted therein.

According to the invention, each padded element 2′, 2″ will be provided with retaining means for coupling to a base element 3, which in turn can have the features illustrated in detail above with reference to the embodiments described above.

Said retaining means can be provided directly on the lining 6′, 6″ of each padded element 2′, 2″, for example by totally or partially making said covering linings of a non-slip material, or by providing said covering linings with discrete retaining means, such as, for example, male/female hook-and-loop strips.

Alternatively, as in the embodiments described above, it will be possible to provide a further cover, capable of covering each padded element individually, or both padded elements together, and to constitute the retaining means on said further cover.

It is evident from the above description that the invention makes it possible to achieve the object set forth above in an effective way.

It is further evident that the embodiments described above have been given merely by way of non-limiting examples, and that several modifications and variations are possible without departing from the scope of the invention as defined by the appended claims.

For example, it is possible to provide a support and restraint system in which the padded element and the base element are equipped with retaining means of different nature, including the possibility that they may comprise, at the same time and in different positions, both retaining means consisting of continuous and distributed elements and retaining means consisting of discrete elements.

1. A support and restraint system for a human body or for a segment of a human body, comprising:
at least one padded element, having a substantially tubular shape, and
at least one base element,
wherein the at least one padded element having a substantially tubular shape and the at least one base element are distinct, independent and entirely separate components,
wherein the at least one padded element and the at least one base element are provided with respective retaining means for coupling the at least one padded element to the at least one base element, and
wherein a desired arrangement on the at least one base element can be given to the at least one padded element and the retaining means to ensure that the at least one padded element firmly maintains the arrangement that is conferred and defined thereto.

2. The support and restraint system according to claim 1, wherein the retaining means are continuous and distributed retaining means.

3. The support and restraint system according to claim 1, wherein the retaining means are discrete retaining means.

4. The support and restraint system according to claim 1, wherein the at least one padded element includes a covering lining and a padding received inside the covering lining.

5. The support and restraint system according to claim 2, wherein the at least one padded element includes a covering lining and a padding received inside the covering lining, and wherein the distributed retaining means are obtained by totally or partially making the covering lining of the at least one padded element of a non-slip material, and by providing the at least one base element with a coating totally or partially made of a non-slip material.

6. The support and restraint system according to claim 2, wherein the at least one padded element includes a covering lining and a padding received inside the covering lining, and wherein the distributed retaining means are obtained by covering the covering lining(s) of the at least one padded element with an additional cover, capable of covering, totally or partially, the at least one padded element, by totally or partially making the additional cover of a non-slip material, and by providing the at least one base element with a coating totally or partially made of a non-slip material.

7. The support and restraint system according to claim 3, wherein the at least one padded element includes a covering lining and a padding received inside the covering lining, and wherein the discrete retaining means are obtained by placing male or, respectively, female connecting members on the at least one base element and by placing corresponding female or, respectively, male connecting members on the covering lining of the at least one padded element.

8. The support and restraint system according to claim 7, wherein the male or, respectively, female connecting members of the at least one base element and the female or, respectively, male connecting members of the at least one padded element allow a removable connection between the at least one base element and the at least one padded element.

9. The support and restraint system according to claim 1, wherein the at least one padded element has an elongated tubular shape, wherein the at least one padded element has a cross-section having a constant size along the length of the at least one padded element, and wherein the at least one padded element has a length much greater than the size of the cross-section.

10. The support and restraint system according to claim 4, wherein the padding of the at least one padded element is divided into several sectors, and wherein each sector of the padding is made by using one or more types and combinations of filling elements, which are identical or different.

11. The support and restraint system according to claim 1, wherein the at least one padded element has an elongated tubular shape, wherein the at least one padded element has a cross-section having a variable size along the length of the at least one padded element, and wherein the at least one padded element has a length much greater than a maximum size of the cross-section.

12. The support and restraint system according to claim 4, wherein the padding of the at least one padded element is made by using one or more types and combinations of filling elements.
